(19) United States
(12) Patent Application Publication
(10) Pub. No.: US 2006/0247338 A1
(43) Pub. Date: Nov. 2, 2006

(54) Poly(arylene ether) compositions with improved ultraviolet light stability, and related articles

(75) Inventors: Steven Raymond Klei, Guilderland, NY (US); James Edward Pickett, Schenectady, NY (US)

Correspondence Address: John B Yates III;GE Advanced Materials, One Plastics Avenue, Pittsfield, MA, 01201, US

(73) Assignee: General Electric Company

(21) Appl. No.: 11/119,955

(22) Filed: May 2, 2005

(51) Int. Cl. C08K 5/34

(52) U.S. Cl. 524/89; 524/508

(57) ABSTRACT

A thermoplastic composition is disclosed, containing poly(arylene ether) resin; vinyl aromatic resin; a hindered amine light stabilizer; an ultraviolet light absorbing compound, and about 0.1% by weight to about 2.0% by weight of titanium dioxide, based on the total weight of poly(arylene ether) resin and vinyl aromatic resin. Other thermoplastic compositions described herein contain poly(arylene ether) resin; vinyl aromatic resin; an ultraviolet light absorbing compound, and at least one methine yellow colorant. Molded articles prepared from these compositions are also described.

### BACKGROUND OF THE INVENTION

This invention generally relates to polymer compositions. More specifically, the invention relates to poly(arylene ether) resins having improved resistance to the detrimental effects of ultraviolet radiation.

Poly(arylene ether) compositions are commercially attractive materials because of their unique combination of physical, chemical, and electrical properties. The resins are usually characterized by a desirable combination of hydrolytic stability, high dimensional stability, toughness, heat resistance and dielectric properties. They also exhibit high glass transition temperature values, typically in the range of about 150° C.-210° C., as well as good mechanical performance. Poly(arylene ether) compositions often include vinyl aromatic polymers such as rubber-modified (high impact) polystyrene (known as “HIPS”), to improve properties like impact strength and processibility. Poly(arylene ether) compositions can be used to form articles in a very wide assortment of colors, by the use of various dyes and pigments. The most common poly(arylene ether) materials are the polyphenylene ether (“PPE”) resins.

Like other polymeric materials, polyarylene ethers sometimes undergo degradation when exposed to ultraviolet (UV) radiation. The degradation manifests itself in various ways, such as yellowing and discoloration. The problem can be especially serious when the poly(arylene ether) resin is used in molded articles exposed to interior lighting, e.g., fluorescent lighting. For example, business equipment formulated in lighter colors, e.g., whites, lighter blues, and lighter grays, is especially susceptible to yellowing and other undesirable color changes. As those skilled in the art understand, color stability generally decreases over time.

A number of routes have been taken to increase the color stability of poly(arylene ether) compositions. In addressing the problem of instability due to poor UV light resistance, various additives have been incorporated into the resin compositions. Important examples of such additives are the benzophenone- and benzotriazole-based UV absorbing compounds, and the hindered amine light stabilizers. As described in many references (e.g., U.S. Pat. No. 4,835,201 to Bopp and U.S. Pat. No. 4,785,076 to Shu), the UV compounds are most often used in specific combination with the hindered amine stabilizers. Such a combination can often provide an efficient means to color-stabilize some of the poly(arylene ether)/polystyrene materials. However, care must be taken in using these types of additive systems. For example, some of the additives are relatively expensive. Furthermore, the additives—especially at higher levels—may sometimes detract from physical properties such as tensile modulus and heat distortion temperature (HDT).

The addition of other components to the poly(arylene ether) compositions can also provide some relief for the color instability problem. For example, one or more dyes are sometimes added to the composition, to “compensate” for the change in color of the polymer constituents upon exposure to UV light. As described in U.S. Pat. No. 4,493,915 (Lohmeijer), individual dyes (e.g., yellow dyes) and dye combinations which bleach upon exposure to light can be very useful for this purpose. In theory, the complete or partial decomposition of the selected dye(s) can desirably cause the bleaching phenomenon, at wavelengths in which visible discoloration would otherwise occur.

Many pigments can be employed to formulate the poly(arylene ether) compositions in various colors. Very often, white pigments such as titanium dioxide (TiO₂), zinc oxide, and zinc sulfide are added to the compositions, to provide a “color base” for lighter-colored products. These pigments can perform other functions as well. For example, the presence of TiO₂ can make the undesirable yellowing of molded articles less apparent to the naked eye. TiO₂ is also used to cover imperfections (e.g., black specks) and other defects in the surface of the molded products. Moreover, TiO₂ can function as an effective filler in many of the poly(arylene ether) compositions.

For many types of polymer resins, relatively high concentrations of TiO₂ are beneficial. This is the case for acrylonitrile-butadiene-styrene (ABS) materials, as well as acrylonitrile-styrene-acrylate (ASA) materials. For example, relatively high TiO₂ levels (e.g., greater than about 2-3 weight %, based on total resin weight) in such materials can be very effective for achieving many lighter colors in the respective, molded products.

However, it has been discovered that some of the poly(arylene ether) compositions are negatively affected by the higher TiO₂ levels. For example, poly(arylene ether)/polystyrene compositions which contain greater than about 3 weight % TiO₂ may surprisingly exhibit decreased UV stability. Although the higher TiO₂ levels may be very desirable for providing a particular color, they also decrease the efficiency of using the conventional UV additives like hindered amines, benzophenones, and benzotriazoles. Thus, greater amounts of the additives may be required to achieve the same stabilization effect, but the increased levels of these compounds can lead to the other problems noted above.

The presence of the higher levels of TiO₂ in the poly(arylene ether) compositions can cause other problems as well. For example, thermal properties may suffer somewhat, and mechanical properties such as impact strength may be lower. Furthermore, higher TiO₂ levels may increase the amount of wear on the extrusion screws. Moreover, clean-up requirements may be greater, since the pigment can be difficult to remove when the same equipment is to be used to process grades of a different color. The increased maintenance time can decrease overall production efficiency.

A balanced optimization of factors such as color/UV stability, mechanical properties, cost considerations, and manufacturing/processing issues has always been a challenge in the case of poly(arylene ether) compositions. However, the challenge has become even greater in recent times. New markets for plastics, and the unprecedented demand for unique colors and surface appearances, have contributed to the more demanding product requirements. At the same time, color stability requirements have increased. Moreover, since costs within the typical polymer plant have often increased significantly (e.g., energy costs), those increased product requirements have to be met with even greater plant efficiency.

It should thus be apparent that a need continues to exist for poly(arylene ether) compositions which exhibit enhanced color stability. Moreover, it would be advantageous if the compositions exhibited physical and mechanical properties which were generally similar to or better than the properties of traditional poly(arylene ether) compositions. Furthermore, it would be beneficial if the compositions could be prepared economically, and without significant alteration to current resin plant processes.

### BRIEF DESCRIPTION OF THE INVENTION

One embodiment of this invention is directed to a thermoplastic composition, comprising:

(a) a poly(arylene ether) resin;

(b) a vinyl aromatic resin;

(c) a hindered amine light stabilizer;

(d) an ultraviolet light absorbing compound; and

(e) about 0.1% by weight to about 2.0% by weight of titanium dioxide, based on the total weight of poly(arylene ether) resin and vinyl aromatic resin.

Another embodiment relates to a thermoplastic composition which comprises:

(I) a poly(arylene ether) resin;

(II) a vinyl aromatic resin;

(III) at least one ultraviolet light absorbing compound; and

(IV) at least one methine colorant.

This composition is often characterized by a color shift (dE) of less than about 11.0, as determined by ASTM D-2244, after weathering according to ASTM D-4459 for 300 hours.

Thermoplastic articles molded from the compositions described above also form part of this invention.

### BRIEF DESCRIPTION OF THE DRAWINGS

FIG. 1 is a graph depicting Delta E color shift values as a function of time, for various poly(arylene ether) compositions.

### DETAILED DESCRIPTION OF THE INVENTION

The poly(arylene ether) resins for the present invention are generally known in the art. Many of them are described in U.S. Pat. Nos. 3,306,874; 3,306,875; and 3,432,469 (Hay); U.S. Pat. No. 4,806,602 (White et al); U.S. Pat. No. 4,806,297 (Brown et al); and U.S. Pat. No. 5,294,654 (Hellstern-Burnell et al), all incorporated herein by reference. Both homopolymer and copolymer polyarylene ethers are within the scope of this invention.

The preferred poly(arylene ether) resins are homo- and copolymers which comprise a plurality of structural units of the formula

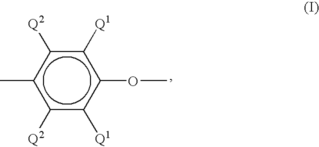

wherein each Q¹ is independently halogen, primary or secondary lower alkyl, phenyl, haloalkyl, aminoalkyl, hydrocarbonoxy, or halohydro-carbonoxy, wherein at least two carbon atoms separate the halogen and oxygen atoms; and each Q² is independently hydrogen, halogen, primary or secondary lower alkyl, phenyl, haloalkyl, hydrocarbonoxy or halohydrocarbonoxy as defined for Q¹. Most often, each Q¹ is alkyl or phenyl, especially C₁₋₄ alkyl; and each Q² is hydrogen.

The preferred poly(arylene ether) resins are often comprised of units derived from 2,6-dimethyl phenol. Also preferred in some instances are poly(arylene ether) copolymers comprised of units derived from 2,6-dimethyl phenol and 2,3,6-trimethyl phenol. The poly(arylene ether) resins of this invention generally have a weight average molecular weight of about 20,000 to 80,000, as determined by gel permeation chromatography. Furthermore, they can be prepared by methods known in the art. One example is the oxidative coupling of an appropriate monohydroxyaromatic compound in the presence of a catalyst based on copper, manganese, or cobalt.

The poly(arylene ether) resins can be blended with many other materials which provide additional attributes. For example, they can be blended with a variety of vinyl aromatic resins. They can also be blended with polyamides, polyarylene sulfides, polyphthalamides, polyetherimides, polyolefins, polyesters; and ABS copolymers (e.g., those based on grafts of styrene and acrylonitrile on a previously formed diene polymer backbone); and with various mixtures and copolymers of any of these materials.

In many embodiments, the vinyl aromatic resins (usually polystyrenes) are frequently blended with the poly(arylene ether) resins, and can be in both homopolymer and copolymer form. Copolymers may include the random, block or graft types. Examples of the homopolymers are amorphous polystyrene and syndiotactic polystyrene. Rubber-modified polystyrene resins like the HIPS materials mentioned above are often preferred. (As those skilled in the art understand, the term “poly(alkenyl aromatic) resins” is sometimes used in place of “vinyl aromatic resins”).

The HIPS materials usually comprise blends and grafts wherein the rubber is a polybutadiene, or a rubbery copolymer of about 70-98% styrene and 2-30% diene monomer. Core-shell polymers, e.g., core-shell graft copolymers of alkenylaromatic and conjugated diene compounds, can also be blended with the PPE resins. Especially suitable are those comprising styrene blocks and butadiene, isoprene or ethylene-butylene blocks. Examples of suitable vinyl aromatic resins and core-shell polymers can be found in U.S. Pat. Nos. 4,684,696; 4,816,510; 5,294,653; and 6,576,700, all incorporated herein by reference.

The relative amounts of poly(arylene ether) resin and vinyl aromatic resin in these compositions can vary widely. Usually, each of these components is present in an amount of about 20 weight % to about 80 weight %, based on the total weight of poly(arylene ether) resin and vinyl aromatic resin. In some specific embodiments, the poly(arylene ether) resin is present in an amount greater than or equal to about 22 weight %, and more specifically, greater than or equal to about 25 weight %. In some especially preferred embodiments, the poly(arylene ether) resin is present in an amount greater than or equal to about 27 weight %.

Moreover, within the overall range, the poly(arylene ether) may be present in an amount less than or equal to about 77 weight %, and more specifically, less than or equal to about 75 weight %. In some especially preferred embodiments, the poly(arylene ether) is present at a level which is less than or equal to about 73 weight percent. The same selection of ranges (both minimum and maximum) is possible for the vinyl aromatic resin.

Very often, the thermoplastic composition comprises at least one hindered amine light stabilizer (“HALS”). These compounds are well-known in the art. For example, many of them are described in U.S. Pat. No. 5,672,644 (Inoue), U.S. Pat. No. 5,045,578 (Claesen et al), U.S. Pat. No. 4,835,201 (Bopp), U.S. Pat. No. 4,785,076 (Shu), and U.S. Pat. No. 4,636,408 (Anthony et al), which are all incorporated herein by reference. The presence of the poly-substitution and/or sterically bulky group at the 2 and 6 positions of a piperidine ring is a structural characteristic of these compounds. Thus, most of these stabilizers comprise at least one moiety of the following structure:

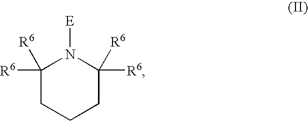

wherein each R⁶ is independently an alkyl group having 1 to about 8 carbons, and each occurrence of E is independently selected from the group consisting of oxyl, hydroxyl, alkoxy, cycloalkoxy, arylalkoxy, aryloxy, —O—CO-OZ³, —O—Si(Z⁴)₃, —O—PO(OZ⁵S)₂, —O—CH₂-OZ⁶, and —O-T-(OH)_{b},

wherein Z³, Z⁴, Z⁵, and Z⁶ are selected from the group consisting of hydrogen, aliphatic hydrocarbons having 1 to about 8 carbons, and aromatic hydrocarbons having 1 to about 8 carbons;

and wherein, for the formula —O-T-(OH)_{b}, T is a straight or branched alkyl of 1 to about 18 carbons, a cycloalkyl of about 5 to about 18 carbons, or an alkylaryl having about 7 to about 14 carbons; and b is 1, 2, or 3, with the proviso that b cannot exceed the number of carbon atoms in T; and when b is 2 or 3, each hydroxyl is attached to a different carbon atom of T. The hindered amine light stabilizers may be monomeric, oligomeric or polymeric.

In one embodiment, the hindered amine light stabilizers may be characterized by the formula:

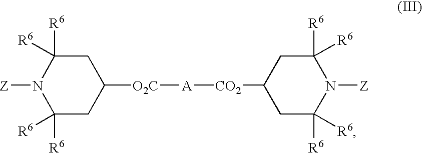

wherein A is an alkanediyl group; R⁶ is defined as above; and each Z can independently be hydrogen or a lower alkyl group of 1 to about 8 carbon atoms; and wherein each pair of R⁶ groups which are attached to a single aromatic ring position can optionally be in the form of a pentamethylene group.

Non-limiting examples of specific hindered amine compounds are as follows: bis(2,2,6,6-tetramethyl-4-piperidyl)sebacate; bis(2,2,6,6-tetramethyl-4-piperidyl)succinate; bis(1,2,2,6,6-pentamethyl-4-piperidyl)sebacate; bis(1-octyloxy-2,2,6,6-tetramethyl-4-piperidyl)sebacate; bis(1,2,2,6,6-pentamethyl-4-piperidyl) n-butyl-3,5-di-tert-butyl-4-hydroxybenzylmalonate; the condensate of 1-(2-hydroxyethyl)-2,2,6,6-tetramethyl-4-hydroxypiperidine and succinic acid; linear or cyclic condensates of N,N′-bis(2,2,6,6-tetramethyl-4-piperidyl)hexamethylenediamine and 4-tert-octylamino-2,6-dichloro-1,3,5-triazine; tris(2,2,6,6-tetramethyl-4-piperidyl)nitrilotriacetate; tetrakis(2,2,6,6-tetramethyl-4-piperidyl)-1,2,3,4-butane-tetracarboxylate; 1,1′-(1,2-ethanediyl)-bis(3,3,5,5-tetramethylpiperazinone). Mixtures which comprise any of the foregoing are also within the scope of the present invention.

Hindered amine stabilizers like those described above are commercially available from a variety of sources. Non-limiting examples of commercial products suitable for this invention include Tinuvin®123, Tinuvin®144, Tinuvin®622, Tinuvin®770, and Tinuvin®765, available from Ciba Specialty Chemicals; and polymeric hindered amines available from Ciba under the names CHIMASSORB®944 and CHIMASSORB®2020.

The amount of hindered amine light stabilizer which is employed will depend on a variety of factors. They include: the specific HALS compound; the type of polymer system (and whether or not a vinyl aromatic compound is present); the level of stabilization required; the presence of other additives such as pigments and dyes; and the presence of other stabilizers (e.g., a UV stabilizer). Usually (though not always), the HALS compound is present at a level in the range of about 0.5 weight % to about 3.0 weight %, based on the total weight of the poly(arylene ether) and poly(alkenyl aromatic) resin. In some specific embodiments, the level of the HALS compound is greater than or equal to about 0.6 weight %, and preferably, greater than or equal to about 0.7 weight %. Within the overall range noted above, the HALS compound is often present at a level less than or equal to about 2.9 weight %, and more specifically, less than or equal to about 2.8 weight %. In some especially preferred embodiments, the level is less than or equal to about 2.7 weight %.

The thermoplastic composition often comprises at least one ultraviolet light (UV) absorbing compound. These additives are well-known in the art and described in many references, e.g., some of the patents listed previously. Usually, the ultraviolet light absorbing compound is selected from the group consisting of benzophenone compounds, benzotriazole compounds, and combinations thereof.

Many (though not all) of the benzophenone compounds suitable for this invention have the formula

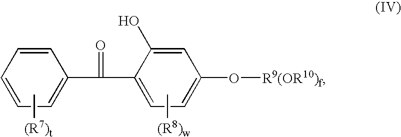

wherein R⁷ and R⁸ are independently hydroxy, straight or branched alkyl groups having from 1 to about 10 carbon atoms, or alkoxy groups having from 1 to about 10 carbon atoms; R⁹ is hydrogen, or a monovalent or divalent radical of a straight or branched alkane having 1 to about 25 carbon atoms, substituted or unsubstituted with a hydroxyl group or groups; R¹⁰ is hydrogen, or a monovalent radical of a straight or branched alkane having 1 to about 25 carbon atoms, substituted or unsubstituted with a hydroxyl group or groups; and

f is zero or 1, but is always zero when R⁹ represents a hydrogen atom; t is zero or an integer of from 1 to about 5; and w is zero or an integer of from 1 to about 3.

Very often, the benzophenone compound is a 2-hydroxybenzophenone derivative. Examples of such derivatives are as follows: 4-hydroxy, 4-methoxy; 4-octyloxy, 4-decyloxy; 4-dodecyloxy; 4-benzyloxy; 4,2′,4′-trihydroxy; and 2′-hydroxy-4,4′-dimethoxy. Non-limiting examples of specific benzophenone compounds which are suitable for this invention are as follows: 2,2′-dihydroxybenzophenone; 2,2′,4,4′-tetrahydroxybenzophenone; 2,2′-dihydroxy-4,4′-dimethoxybenzophenone; 2,2′-dihydroxy-4,4′-diethoxybenzophenone; 2,2′-dihydroxy-4,4′-dipropoxybenzophenone; 2,2′-dihydroxy-4,4′-dibutoxybenzophenone; 2,2′-dihydroxy-4-methoxy-4′-ethoxybenzophenone; 2,2′-dihydroxy-4-methoxy-4′-propoxybenzophenone; 2,2′-dihydroxy-4-methoxy-4′-butoxybenzophenone; and 2,2′-dihydroxy-4-ethoxy-4′-propoxybenzophenone. Commercial examples of some of the benzophenones are Cyasorb™UV-9, Cyasorb™UV-24, Cyasorb™UV-531, and Cyasorb™UV-2126, available from Cytec Industries Inc.; and Uvinul®3000 and 3040, from BASF.

A variety of benzotriazole compounds are useful in the poly(arylene ether) compositions. Non-limiting examples include: 2-(2′-hydroxy-5′-methylphenyl)-benzotriazole; 2-(3′,5′-di-tert-butyl-2′-hydroxyphenyl)benzotriazole; 2-(5′-tert-butyl-2′-hydroxyphenyl)benzotriazole; 2-(2′-hydroxy-5′-(1,1,3,3-tetramethylbutyl)phenyl)benzotriazole; 2-(3′,5′-di-tert-butyl-2′-hydroxyphenyl)-5-chloro-benzotriazole; 2-(3′-tert-butyl-2′-hydroxy-5′-methylphenyl)-5-chloro-benzotriazole; 2-(3′-sec-butyl-5′-tert-butyl-2′-hydroxyphenyl)benzotriazole; 2-(2′-hydroxy-5′-cyclohexylphenyl)-benzotriazole; 2-(2′-hydroxy-3′-methyl-5′-tert-butylphenyl)-benzotriazole; 2-(2′-hydroxy-3′,5′-dimethylphenyl)-benzotriazole; and 2-(2-hydroxy-5-t-octylphenyl)-benzotriazole.

The appropriate amount of UV absorber will depend in part on many of the factors listed above, in regard to the hindered amine light stabilizer. The total amount of UV absorber is typically in the range of about 0.5 weight % to about 5.0 weight %, based on the total weight of the poly(arylene ether) and poly(alkenyl aromatic) resin. In some specific embodiments, the level of UV absorber is greater than or equal to about 0.6 weight %, and preferably, greater than or equal to about 0.7 weight %. In some especially preferred embodiments, the level of UV absorber is greater than or equal to about 0.8 weight %. Within the overall range noted above, the UV absorber is often present at a level less than or equal to about 4.9 weight %, and more specifically, less than or equal to about 4.8 weight %. In some especially preferred embodiments, the level is less than or equal to about 4.7 weight %.

As mentioned above, the compositions for certain embodiments of this invention contain titanium dioxide. As those skilled in the art recognize, titanium dioxide is characterized by high opacity, brilliant whiteness, excellent covering power, and resistance to color change. The titanium dioxide can be in various forms, e.g., anatase or rutile. Very often, the titanium dioxide used in these resin compositions is in rutile form. Moreover, as those skilled in the art understand, the titanium dioxide is preferably surface-treated, e.g., coated with a passivating material. The TiO₂ is usually used in powder form, although other forms are possible, such as whiskers and granules.

In some of the embodiments of this invention which include titanium dioxide, it is important that this pigment be present in limited amounts. The maximum level for these embodiments is about 2.0% by weight, based on the total weight of the resin components in the composition (e.g., the poly(arylene ether) resin and the vinyl aromatic resin). In some specific embodiments, the maximum level is about 1.5% by weight, while in some very specific embodiments, the maximum level is about 1.0% by weight. The minimum level for these embodiments is usually about 0.1% by weight. The present inventors have discovered that limiting the amount of titanium dioxide in this manner results in maximum UV stability, as described further below, e.g., in the examples. Although the number of colors available for the molded article may be reduced because of the restricted titanium dioxide levels, the benefit in terms of color stability often represents a highly desirable compromise. (As also noted below, other embodiments of this invention, e.g., those directed to methine colorants, do not usually include a specific limitation on titanium dioxide levels).

The compositions of this invention can be formed into articles in a wide variety of colors. The colors are obtained by selecting colorants or combinations of colorants which are used in conjunction with the titanium dioxide. As described by Lohmeijer in U.S. Pat. No. 4,493,915, the colorant package is selected to compensate for the change in color of the polymeric constituents upon exposure to light. The color compensation often occurs by way of a bleaching mechanism.

As used herein, the term “colorants” is meant to include both dyes and pigments, which may be organic or inorganic. Some general information regarding dyes and pigments is provided in U.S. Pat. No. 6,355,723 (van Baal et al), which is incorporated herein by reference. Colorants used in thermoplastics are also described in “A Primer on Colorful Additives”, Ronald Harris (Editor), Plastics Design Library, 1999. The well-known Color Index names many different chemical classes of colorants. Examples include nitroso, nitro, mono-azo, diazo, triazo, polyazo, azoic, stilbene, carotenoid, diphenylmethane, triarylmethane, xanthene, quinoline, acridine, thiazole, indamine, indophenol, azine, oxazine, thiazine, sulfur, lactone, aminoketone, hydroxyketone, anthraquinone, indigloid, and phthalocyanine, as well as inorganic pigments.

Choice of colorant or combinations of colorants will of course depend in large part on the particular color desired. Non-limiting examples of colorants commonly used in poly(arylene ether) compositions are as follows: Perylene Red, Solvent Blue 104, Solvent Green 3, Pigment White 6, Pigment Red 101, Pigment Yellow 138, Solvent Violet 13, rare earth aluminates (luminescent pigments), organic interference pigments, and interference pigments based on lamellar structures. Fluorescent dyes may also be employed, including, but not limited to, Amaplast Orange LFP (Solvent Orange 60). It is also contemplated that pigments such as zinc sulfide, carbon black, cobalt chromate, cobalt titanate, cadmium sulfides, iron oxide, sodium aluminum sulfosilicate, sodium sulfosilicate, chrome antimony titanium rutile, nickel antimony titanium rutile, and zinc oxide may be employed. Angular metameric pigments, i.e., pigments which change color depending on the viewing angle, may also be employed. Hard particulate pigments that remain discrete during compounding and/or blending may also be used.

Yellow colorants are often used in combination with the titanium dioxide, to produce a number of colors which are popular for various molded articles. Non-limiting examples include yellow dyes and pigments from the anthraquinone, azo, and aminoketone families. In some embodiments which are described in more detail below, the use of methine dyes when a yellow color component is required for a particular grade provides unexpected advantages in UV stability.

The poly(arylene ether) compositions may also include effective amounts of a variety of additives, all known in the art. Non-limiting examples include flame retardants, lubricants, heat stabilizers, processing stabilizers, antioxidants, antistatic agents, plasticizers, fillers, reinforcing agents; anti-drip agents, processing aids, mold release agents, visual effects additives (e.g., metal flakes), and various combinations thereof. The levels of effectiveness can be determined without undue experimentation, but usually range, for each additive, from about 0.1% by weight to about 10% by weight, based on the weight of the entire composition. In the case of the flame retardants, the level may be up to about 20% by weight. In the case of additives like the fillers and reinforcing agents, the level (for each) may be higher, e.g., up to about 40% by weight.

Another embodiment of this invention is directed to poly(arylene ether) compositions which contain at least one methine colorant. The present inventors have discovered that the use of the methine colorant (in dye or pigment form) has resulted in significant, unexpected improvements in color stability, as compared to similar colorants used in poly(arylene ether) compositions.

Many methine compounds are suitable for this invention. They are usually characterized by the presence of the methine group 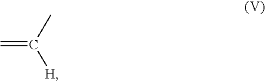
in the compound's chemical structure. The bonding sites on the methine group of formula (V) may accommodate a very large number of chemical elements and chemical groups. Frequently, the group attached to the carbon with the double bond is an electrophilic group, while the group attached to the carbon with the single bond is an aromatic group. In general, non-limiting examples of groups which can be attached to the bonding sites of the methine group are as follows: alkyl, cycloalkyl, hydroxy, alkoxy, halogen, aryl (e.g., phenyl), biphenyl, azo, cyano, ester, naphthyl, imine, and anilino. Multiple aromatic ring structures may be attached to the methine moiety. Moreover, any of the groups attached to the methine moiety, directly or indirectly, may include substituents, e.g., cycloalkyl groups substituted with alkyl groups, halogens, cyano, carboxy, amino, ether, ketone, and the like. Alkyl groups (as well as similar groups, e.g., alkenyl) which are attached to the methine moiety may be straight or branched. A large number of suitable groups which can be present in methine compounds are listed in U.S. Pat. No. 5,086,161 (Weaver et al), which is incorporated herein by reference. Furthermore, the methine-based material may actually be one which contains more than one methine group, e.g., bis- or tris-methines, as described in the Weaver patent. Moreover, polymethine materials are also considered herein to be methine yellow colorants.

Suitable methine colorants are also described in the following U.S. patents: U.S. Pat. No. 4,391,886 (Frishberg et al); U.S. Pat. No. 4,605,441 (Masuda et al); U.S. Pat. No. 4,705,567 (Hair et al); U.S. Pat. No. 4,981,516 (Kluger et al); and U.S. Pat. No. 6,770,331 (Mielke et al). All of these patents are incorporated herein by reference. Other methine colorants are described in “Synthesis and Absorption Spectral Properties of Bis-Methine Dyes Exemplified by 2,5-Bis-Arylidene-1-Dicyanomethylene-Cyclopentanes”, by A. Asiri, Bull. Korean Chem. Soc. 2003, Vol. 24, No. 4, pp. 426-430.

Provided below are the structures of some of the methine colorants useful for the present invention:

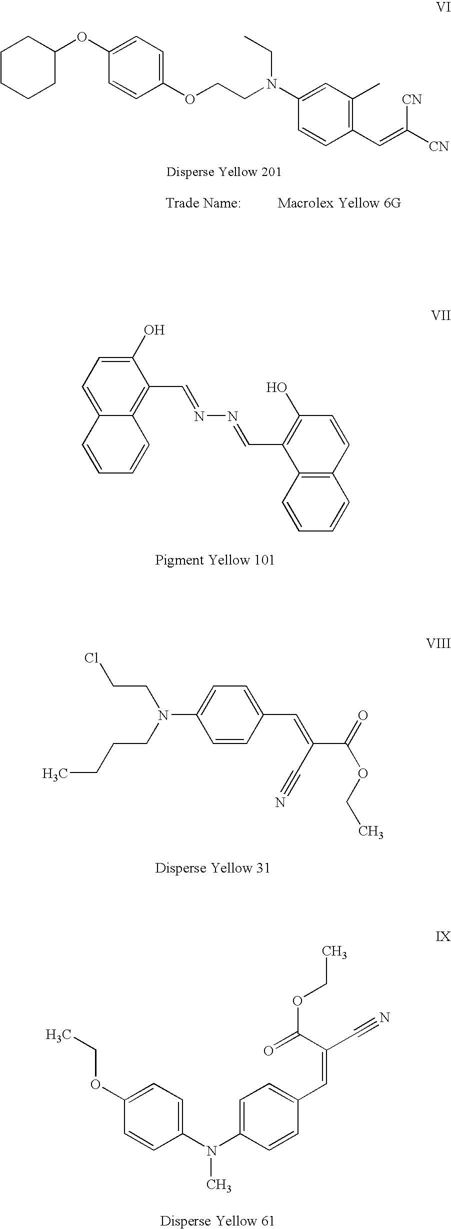

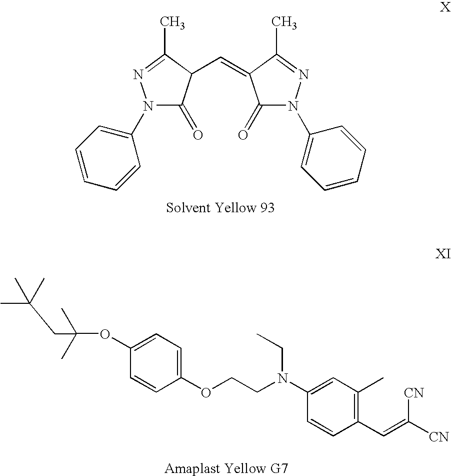

Methine materials having the following structure can also be used in the poly(arylene ether) compositions:

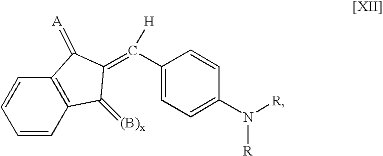

wherein each A and B is independently oxygen or C(CN)₂. Each R and R′ in formula XII can, independently, be various groups (substituted or unsubstituted), such as alkyl, cycloalkyl, hydroxy, alkoxy, halogen, aryl, biphenyl, azo, and cyano; and x is either 1 or zero.

Many of the methine materials are well-known in the art, and available commercially. (They are often identified by their common name). In addition to the compounds listed above, the following methine dyes are also suitable for this invention:

Basic Yellow 11,

Basic Yellow 12,

Basic Yellow 21,

Solvent Yellow 79,

Solvent Yellow 145 (Yellow Oracet 8GF),

Solvent Yellow 147,

Solvent Yellow 168,

Solvent Yellow 169,

Solvent Yellow 170,

Solvent Yellow 171, and

Pigment Yellow 117.

A preferred group of methine compounds for some embodiments comprises: Solvent Yellow 93, Solvent Yellow 145, Disperse Yellow 201 (Macrolex™ Yellow 6G), and Amaplast Yellow G7. (The Amaplast Yellow G7 material is sometimes also referred to as “Disperse Yellow 201”. Its structure is provided above). In especially preferred embodiments, the methine compound is Disperse Yellow 201 (Macrolex™ Yellow 6G).

In preferred embodiments, the methine compound is present in the poly(arylene ether) composition with at least one ultraviolet light absorber. (Suitable UV absorbers have been described previously). In these embodiments, a benzotriazole-type UV absorber is often most preferred, although a benzophenone compound may also be very suitable. Furthermore, a hindered amine light stabilizer is also present in some embodiments. However, those skilled in the art understand that the hindered amine light stabilizer compound may not be necessary. For example, relatively high amounts of the UV absorber may compensate for the absence of the hindered amine light stabilizer compound.

Moreover, the methine-containing poly(arylene ether) compositions usually (but not always) include vinyl aromatic resins, like those described previously. Frequently, the vinyl aromatic resin is a HIPS material. The ratio of poly(arylene ether) to vinyl aromatic resin is within the ranges set forth above.

The appropriate amount of methine yellow colorant will depend on many factors. They include: the specific methine colorant employed; the specific poly(arylene ether) resin used; the desired color for products made with the resin; the presence of vinyl aromatic resins; the conditions under which the resin product is used (e.g., its projected UV exposure); the type and presence of hindered amine light stabilizer compounds and UV absorbers; and the presence or absence of other colorants. Usually, the methine compound is present at a level of at least about 0.015 parts by weight, based on 100 parts of the resin components in the composition (i.e., poly(arylene ether) and the vinyl aromatic resin compound, as well as any resinous impact modifiers). In some preferred embodiments, the level of methine compound is at least about 0.025 parts by weight, and most preferably, at least about 0.03 parts by weight. The maximum amount of methine compound is usually about 0.2 parts by weight, and more specifically, about 0.1 parts by weight. Those of ordinary skill in the art will be able to select the most appropriate level of methine compound, based on the teachings herein.

In general, the compositions of this invention are prepared by melt-blending the various ingredients to form an intimate blend, according to conventional procedures. Such conditions often include mixing in a single or twin-screw type extruder, or in similar mixing devices which can apply a shear to the components. All of the ingredients may be added initially to the processing system, or else certain additives may be pre-compounded with one or more of the primary components—preferably the PPE and/or the vinyl aromatic polymer. Ingredients such as the colorants are sometimes added at a downstream port on the extruder. Moreover, a master-batch is sometimes prepared initially, containing a portion of one or more of the base resins, along with all or a portion of the colorants and the various additives. The master-batch can then be combined with the remainder of the formulated ingredients during the blending process, e.g., during extrusion. Use of the master-batch and use of color concentrates when making the composition can facilitate dispersion of the various components, and can decrease color change cycle time.

Another embodiment of this invention is directed to articles prepared from the compositions described previously. The articles can be made by any conventional technique known in the art. Non-limiting examples include injection molding, thermoforming, blow-molding, calendering, and the like.

These compositions can be used to form a wide variety of thermoplastic articles. However, the articles which benefit most from this invention are those which have very specific requirements for color stability, UV stability, and the like. Non-limiting examples include automotive components, television and computer monitors, business equipment, lighting fixtures, hand-held devices, medical equipment, and exercise equipment.

### EXAMPLES

The examples which follow are merely illustrative, and should not be construed to be any sort of limitation on the scope of the claimed invention.

### Example 1

The following materials were used in this example:

TABLE 1

| Component^{(a)} | Amount | | Description |
|---|---|---|---|
| Poly(arylene | 50-55 | pbw^{(b)} | Poly(2,6-dimethyl-1,4- |
| ether) | | | phenylene) ether resin |
| | | | having an intrinsic |
| | | | viscosity, in chloroform at |
| | | | 25° C., of about 0.4 dl/g. |
| High Impact | 50-55 | pbw | Commercially-available, |
| Polystyrene | | | rubber-modified |
| (HIPS) | | | polystyrene with a melt |
| | | | flow index (MFI) of about |
| | | | 3 grams/10 minutes at 200° |
| | | | C. and 5 kilograms. |
| Flame | 13 | pbw | Kronitex ®50, an |
| retardant/ | | | isopropylated triphenyl |
| plasticizers | | | phosphate compound. |

| | | |
|---|---|---|
| TiO₂ | Variable - | Titanium Dioxide |
| | See Below^{(c)} | |

^{(a)}Each of the compositions additionally contained less than 3 pbw of various additives (heat stabilizers, mold release agents, etc.)
^{(b)}pbw = parts by weight, based on 100 parts resin
^{(c)}TiO₂ concentrations were: 0 pbw; 3 pbw; 6 pbw; and 10 pbw, based on total weight of poly(arylene ether) and HIPS.

Each of the compositions was prepared by pre-blending the ingredients at ambient temperature, using a mixer, and then extruding the pre-blend through a twin-screw extruder at about 540° F.-580° F. (282° C.-304° C.). The extrudate was then injection-molded into test pieces. The molded samples were evaluated for long-term UV light resistance by exposure in a UV test apparatus, designed to simulate indoor fluorescent lighting. The test is described in U.S. Pat. No. 4,843,116 (Bopp), incorporated herein by reference; and in “Mechanisms of Polymer Degradation and Stabilisation”, Gerald Scott, Editor, Elsevier Applied Science, New York, 1990 (See Chapter 5, “Photodegradation and Stabilization of PPO® Resin Blends”). In the accelerated light test, the ultraviolet light irradiance is approximately 10 times more intense than a typical indoor office exposure. In the present instance, the fluorescent light output to which the samples were exposed simulated two years of indoor office lighting.

In this example, the UV light resistance was expressed in terms of the yellowness index, YI, according to ASTM D-1925. In general, a delta YI of about 2 is barely discernible, while a change of 4 is clearly visible, and considered to be at the failure point.

TABLE 2

| Sample Number | TiO₂ Concentration | Delta YI |
|---|---|---|
| 1 | 0 | 3 |
| 2 | 3 | 13 |
| 3 | 6 | 17 |
| 4 | 10 | 18 |

The data of Table 2 demonstrate that reduced levels of TiO₂ dramatically improve the color stability of the poly(arylene ether) compositions. Conversely, increasing the level of TiO₂ to 3 pbw or higher results in an undesirable, significant increase in color shift for the resin.

This result was very surprising, since the color stability for other conventional resins typically increases with increasing levels of TiO₂. As one example, samples of a commercial ASA (acrylonitrile-styrene-acrylate) resin which contained varying amounts of TiO₂ were weathered, and then tested for UV stability. (In this instance, the weathering test was carried out according to an outdoor protocol, ASTM G26.). The results indicated that the resin samples exhibited much better UV stability at higher TiO₂ levels, as compared to lower TiO₂ levels.

As another comparison-example, samples of a commercial ABS (acrylonitrile-butadiene-styrene) resin were also tested for UV stability. Each sample contained a different amount of TiO₂. (Other pigments which were present were maintained at constant levels). All of the samples visually appeared to be the same color (medium gray). In this instance, the samples were subjected to an accelerated indoor UV stability test (ASTM D-4674-87), which is sometimes referred to as the “HPUV” test.

The color change in this case was measured as a Delta E value, according to ASTM D-2244. For this test, a Gretag MacBeth spectrophotometer was calibrated to measure color, using the reflectance mode. The spectrophotometer produced a set of color values for each sample, according to the well-known Hunter “L, a, b” scale. For such a scale, the “a” value measures green-to-red; the “b” value measures yellow-to-blue; and the “L” value measures white-to-black.

For the ABS compositions, a resin sample which had a total pigment concentration of 1.4 pbw exhibited a Delta E color shift of 1.9. In marked contrast, a resin sample which had a total pigment concentration of 2.4 pbw (i.e., twice the pigment level) exhibited a Delta E color shift of only 0.39.

### Example 2

Each of the poly(arylene ether) resin samples listed below had an identical base composition, as follows^{(a)}:

| | | |
|---|---|---|
| PPE resin* | 48.64 | pbw |
| High Impact Polystyrene (HIPS)** | 48.64 | pbw |
| HALS Tinuvin ® 770 | 0.5 | pbw |
| Benzotriazole UV Absorber*** | 1.0 | pbw |
| Titanium Dioxide (TiO₂) | 3.0 | pbw |

*Poly(2,6-dimethyl-1,4-phenylene) ether resin having an intrinsic viscosity, in chloroform at 25° C., of about 0.4 dl/g.
**“HIPS: A rubber-modified alkenyl aromatic resin having a polybutadiene content of about 7.5-9 weight %.
***Cyasorb 5411 (2-(2-hydroxy-5-t-octylphenyl)-benzotriazole), from Cytec Industries, Inc.

(a) The resin samples also contained less than 2 pbw of various additives (heat stabilizers, mold release agents, etc.)

The respective samples each contained a particular type of yellow colorant, as shown in Table 3. Samples 5 and 6 (Disperse Yellow 201) were the only samples which contained a methine-based colorant. The samples were prepared according to conventional techniques similar to those used for the samples of Example 1, i.e., pre-blending of the ingredients, followed by extrusion at about 540° F.-580° F. (282° C.-304° C.). The extrudate was then injection-molded into test pieces.

The molded samples were evaluated for weathering characteristics, using the xenon arc test according to ASTM D-4459, based on 300 hours exposure. The color shift (dE) was evaluated according to ASTM D-2244, as described above. The results are shown in Table 3.

TABLE 3

| | | Amount of | Delta E Color |
|---|---|---|---|
| Sample # | Type of Colorant | Colorant^{(c)} | Shift^{(d)} |
| 1 | Yellow K0961 HD* | 0.01 pbw | 15.3 |
| 2 | Yellow K0961 HD* | 0.03 pbw | 11.4 |
| 3 | Yellow 110** | 0.01 pbw | 20.0 |
| 4 | Yellow 110 | 0.03 pbw | 15.2 |
| 5 | Yellow 201*** | 0.01 pbw | 15.6 |
| 6 | Yellow 201 | 0.03 pbw | 9.9 |
| 7 | Yellow 183**** | 0.01 pbw | 20.6 |
| 8 | Yellow 183 | 0.03 pbw | 16.0 |
| 9 | Yellow 163^{(a)} | 0.01 pbw | 18.6 |
| 10 | Yellow 163 | 0.03 pbw | 13.5 |
| 11 | Yellow K0961 HD^{(b)} | 0.01 pbw | 15.8 |
| 12 | Yellow K0961 HD | 0.03 pbw | 11.3 |

*K0961HD: Paliotol ™ K0961 (Pigment Yellow 138), available from BASF
**Yellow 110: Pigment Yellow 110, Ciba Irgazin Yellow 3RTLN
***Yellow 201: (Disperse Yellow 201) - methine colorant as described above, available as Macrolex ™ Yellow 6G, from Lanxess Corporation.
****Yellow 183: BASF Paliotol ™ Yellow K2270
^{(a)}Yellow 163: Solvent Yellow 163 - ColorChem Amaplast ® Yellow GHS
^{(b)}The Paliotol ™ K0961HD samples were evaluated in duplicate.
^{(c)}pbw - parts by weight, based on total weight of PPE, HIPS, and additives, excluding UV absorber and HALS
^{(d)}Delta E according to ASTM D-2244

The data in Table 3 demonstrate that the methine compound of sample 6, Disperse Yellow 201, exhibited a significantly lower Delta E color shift than any of the other samples. It should be noted that the Disperse Yellow 201 performed better than Yellow Paliotol™ K0961HD (samples 2 and 12) at levels of 0.03 pbw. (Yellow Paliotol K0961 is described as a preferred yellow colorant in U.S. Pat. No. 4,493,915). At the lower level of 0.01 pbw (sample 5), the Delta E color shift for Disperse Yellow 201 was about equal to that of Yellow Paliotol™ K0961HD (samples 1 and 11), although the value was significantly better than the respective values for the remainder of the samples at that loading.

### Example 3

Polyphenylene ether compositions with various yellow colorants were also tested for long-term UV stability, using the light test designed to simulate indoor fluorescent lighting, i.e., as in Example 1. The base formula for the PPE compositions was identical to that of Example 2. In each of these samples, one of a set of yellow colorants was added, at either the 0.01 pbw level or the 0.03 pbw level (based on 100 parts of PPE and HIPS). The samples were prepared as in the previous examples, i.e., pre-blending of the ingredients, followed by extrusion at about 540° F.-580° F. (282° C.-304′ C). The extrudate was then injection-molded into 2 inch×3 inch (5.1 cm×7.6 cm) test plaques.

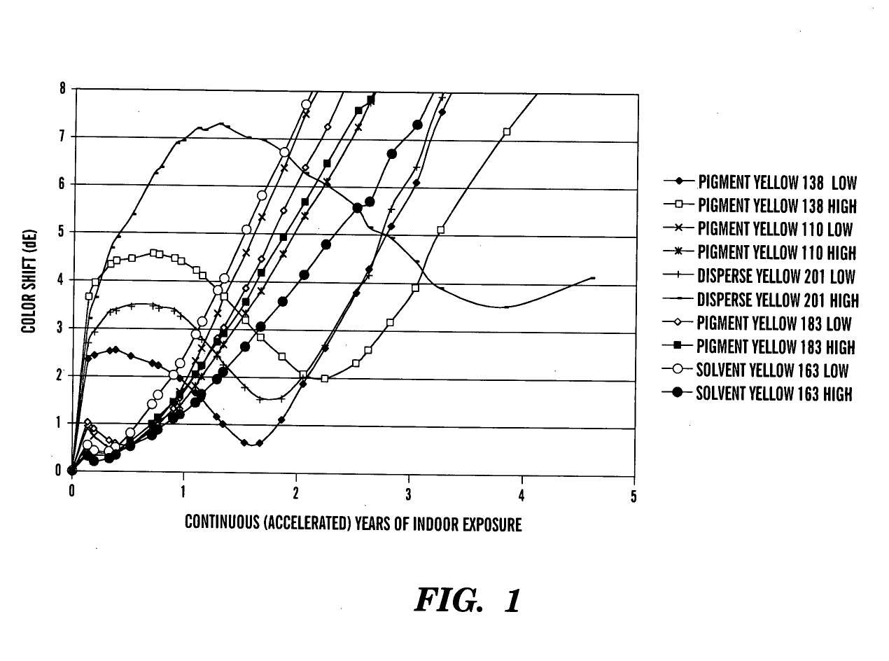

Delta E measurements were made on the test plaques every 2-7 days (continuous exposure), using the calibrated spectrophotometer mentioned previously. The plaques were read by the spectrophotometer, using the untextured side of the plaque. The results for representative samples are displayed graphically in FIG. 1. In the key for the figure, “low” designates the 0.01 pbw level, and “high” designates the 0.03 pbw level. To assist in identification of the curves in the figure, it should be noted that the curves appear in the following order, going from left to right at the exemplary “dE” level of 7: 201 High, 163 Low, 110 Low, 183 Low, 183 High, 110 High, 163 High, 201 Low, 138 Low, and 138 High.

FIG. 1 demonstrates that compositions which utilized 0.03 pbw of Disperse Yellow 201 again exhibited the best performance (lowest Delta E), after 4 years of extrapolated time (i.e., 5 months actual exposure). Thus, it is apparent that the significant advantage of using Disperse Yellow 201 in the poly(arylene ether) compositions has been shown by way of two different types of UV evaluations. (With reference to FIG. 1, the initial increase in Delta E for Disperse Yellow 201, i.e., at about 0.5 to 1.5 accelerated years, appeared to be mainly attributable to an increase in the “b” value of the color set. This shift toward a blue color is generally not considered to be a substantial drawback, in view of the fact that yellowing is the primary concern).

Persons of ordinary skill in the art will recognize the utility of variations and additions that are possible in both the apparatus and method of use disclosed herein, without departing from the scope of this invention. Accordingly, it is understood that the scope is to be limited only by the appended claims. All of the patents, articles, and texts which are mentioned above are incorporated herein by reference.

What is claimed:

1. A thermoplastic composition, comprising:
(a) a poly(arylene ether) resin;
(b) a vinyl aromatic resin;
(c) a hindered amine light stabilizer;
(d) an ultraviolet light absorbing compound; and
(e) about 0.1% by weight to about 2.0% by weight of titanium dioxide, based on the total weight of poly(arylene ether) resin and vinyl aromatic resin.

2. The thermoplastic composition of claim 1, wherein the poly(arylene ether) is present in an amount of about 20 weight % to about 80 weight %, based on the total weight of poly(arylene ether) resin and vinyl aromatic resin.

3. The thermoplastic composition of claim 2, wherein the poly(arylene ether) resin is a homopolymer or a copolymer, and comprises poly(2,6-dimethyl-1,4-phenylene ether).

4. The thermoplastic composition of claim 1, wherein the vinyl aromatic resin is rubber-modified.

5. The thermoplastic composition of claim 1, wherein the vinyl aromatic resin is present in an amount of about 20 weight % to about 80 weight %, based on the total weight of poly(arylene ether) resin and vinyl aromatic resin.

6. The thermoplastic composition of claim 1, wherein the hindered amine light stabilizer comprises a monomeric, oligomeric or polymeric material.

7. The thermoplastic composition of claim 1, wherein the hindered amine light stabilizer comprises at least one moiety of the following structure: 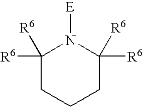
wherein each R⁶ is independently an alkyl group having 1 to about 8 carbons, and each occurrence of E is independently selected from the group consisting of oxyl, hydroxyl, alkoxy, cycloalkoxy, arylalkoxy, aryloxy, —O—CO-OZ³, —O—Si(Z⁴)₃, —O—PO(OZ⁵S)₂, —O—CH₂-OZ⁶, and —O-T-(OH)_{b},
wherein Z³, Z⁴, Z⁵, and Z⁶ are selected from the group consisting of hydrogen, aliphatic hydrocarbons having 1 to about 8 carbons, and aromatic hydrocarbons having 1 to about 8 carbons;
and wherein, for the formula —O-T-(OH)_{b}, T is a straight or branched alkyl of 1 to about 18 carbons, a cycloalkyl of about 5 to about 18 carbons, or an alkylaryl having about 7 to about 14 carbons; and b is 1, 2, or 3, with the proviso that b cannot exceed the number of carbon atoms in T; and when b is 2 or 3, each hydroxyl is attached to a different carbon atom of T.

8. The thermoplastic composition of claim 7, wherein the hindered amine light stabilizer comprises a compound of the formula 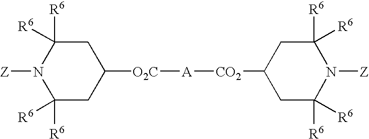
wherein A is an alkanediyl group; R⁶ is defined as above; and each Z can independently be hydrogen or a lower alkyl group of 1 to about 8 carbon atoms; and wherein each pair of R⁶ groups which are attached to a single aromatic ring position can optionally be in the form of a pentamethylene group.

9. The thermoplastic composition of claim 1, wherein the hindered amine light stabilizer is selected from the group consisting of bis(2,2,6,6-tetramethyl-4-piperidyl)sebacate; bis(2,2,6,6-tetramethyl-4-piperidyl)succinate; bis(1,2,2,6,6-pentamethyl-4-piperidyl)sebacate; bis(1-octyloxy-2,2,6,6-tetramethyl-4-piperidyl)sebacate; bis(1,2,2,6,6-pentamethyl-4-piperidyl) n-butyl-3,5-di-tert-butyl-4-hydroxybenzylmalonate; the condensate of 1-(2-hydroxyethyl)-2,2,6,6-tetramethyl-4-hydroxypiperidine and succinic acid; linear or cyclic condensates of N,N′-bis(2,2,6,6-tetramethyl4-piperidyl)hexamethylenediamine and 4-tert-octylamino-2,6-dichloro-1,3,5-triazine; tris(2,2,6,6-tetramethyl-4-piperidyl)nitrilotriacetate; tetrakis(2,2,6,6-tetramethyl-4-piperidyl)-1,2,3,4-butane-tetracarboxylate; 1,1′-(1,2-ethanediyl)-bis(3,3,5,5-tetramethylpiperazinone); and mixtures which comprise any of the foregoing.

10. The composition of claim 1, wherein the hindered amine light stabilizer is present in an amount of about 0.5 weight % to about 3.0 weight percent, based on the total weight of poly(arylene ether) resin and vinyl aromatic resin.

11. The composition of claim 1, wherein the ultraviolet light absorbing compound is selected from the group consisting of benzophenone compounds, benzotriazole compounds, and combinations thereof.

12. The composition of claim 11, wherein the benzophenone compound has the formula 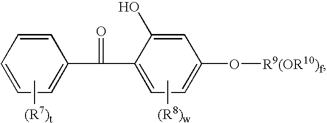
wherein R⁷ and R⁸ are independently hydroxy, straight or branched alkyl groups having from 1 to about 10 carbon atoms, or alkoxy groups having from 1 to about 10 carbon atoms; R⁹ is hydrogen, or a monovalent or divalent radical of a straight or branched alkane having 1 to about 25 carbon atoms, substituted or unsubstituted with a hydroxyl group or groups; R¹⁰ is hydrogen, or a monovalent radical of a straight or branched alkane having 1 to about 25 carbon atoms, substituted or unsubstituted with a hydroxyl group or groups; and
f is zero or 1, but is always zero when R⁹ represents a hydrogen atom; t is zero or an integer of from 1 to about 5; and w is zero or an integer of from 1 to about 3.

13. The composition of claim 11, wherein the benzophenone compound is a 2-hydroxybenzophenone derivative selected from the group consisting of 4-hydroxy, 4-methoxy; 4-octyloxy, 4-decyloxy; 4-dodecyloxy; 4-benzyloxy; 4,2′,4′-trihydroxy; and 2′-hydroxy-4,4′-dimethoxy.

14. The composition of claim 11, wherein the benzophenone compound is selected from the group consisting of 2,2′-dihydroxybenzophenone; 2,2′,4,4′-tetrahydroxybenzophenone; 2,2′-dihydroxy-4,4′-dimethoxybenzophenone; 2,2′-dihydroxy-4,4′-diethoxybenzophenone; 2,2′-dihydroxy-4,4′-dipropoxybenzophenone; 2,2′-dihydroxy-4,4′-dibutoxybenzophenone; 2,2′-dihydroxy-4-methoxy-4′-ethoxybenzophenone; 2,2′-dihydroxy-4-methoxy-4′-propoxybenzophenone; 2,2′-dihydroxy-4-methoxy-4′-butoxybenzophenone; and 2,2′-dihydroxy-4-ethoxy-4′-propoxybenzophenone.

15. The composition of claim 11, wherein the benzotriazole compound is selected from the group consisting of 2-(2′-hydroxy-5′-methylphenyl)-benzotriazole; 2-(3′,5′-di-tert-butyl-2′-hydroxyphenyl)benzotriazole; 2-(5′-tert-butyl-2′-hydroxyphenyl)benzotriazole; 2-(2′-hydroxy-5′-(1,1,3,3-tetramethylbutyl)phenyl)benzotriazole; 2-(3′,5′-di-tert-butyl-2′-hydroxyphenyl)-5-chloro-benzotriazole; 2-(3′-tert-butyl-2′-hydroxy-5′-methylphenyl)-5-chloro-benzotriazole; 2-(3′-sec-butyl-5′-tert-butyl-2′-hydroxyphenyl)benzotriazole; 2-(2′-hydroxy-5′-cyclohexylphenyl)-benzotriazole; 2-(2′-hydroxy-3′-methyl-5′-tert-butylphenyl)-benzotriazole; 2-(2′-hydroxy-3′,5′-dimethylphenyl)-benzotriazole; and 2-(2-hydroxy-5-t-octylphenyl)-benzotriazole.

16. The composition of claim 11, wherein the ultraviolet light absorbing compound is present in an amount of about 0.5 weight % to about 5 weight %, based on the total weight of poly(arylene ether) resin and vinyl aromatic resin.

17. The composition of claim 1, wherein titanium dioxide is present at a level of about 0.1% by weight to about 1.0% by weight, based on the total weight of poly(arylene ether) resin and vinyl aromatic resin.

18. The composition of claim 1, wherein titanium dioxide is present at a level of about 0.1% by weight to about 0.5% by weight, based on the total weight of poly(arylene ether) resin and vinyl aromatic resin.

19. The composition of claim 1, further comprising at least one additive selected from the group consisting of colorants, flame retardants, lubricants, heat stabilizers, processing stabilizers, antioxidants, antistatic agents, plasticizers, fillers, reinforcing agents; anti-drip agents, processing aids, mold release agents, visual effects additives; and combinations thereof.

20. The composition of claim 1, comprising at least one yellow colorant.

21. A thermoplastic composition, comprising:
(i) about 20 weight % to about 80 weight % of at least one polyphenylene ether resin;
(ii) about 20 weight % to about 80 weight % of a rubber-modified polystyrene resin.
(iii) about 0.5 weight % to about 3.0 weight % of at least one hindered amine light stabilizer, based on the weight of components (i) and (ii);
(iv) about 0.5 weight % to about 5 weight % of at least one ultraviolet light absorbing compound, based on the weight of components (i) and (ii); and
(v) about 0.1% by weight to about 2.0% by weight of titanium dioxide, based on the weight of components (i) and (ii).

22. A thermoplastic composition, comprising:
(I) a poly(arylene ether) resin;
(II) a vinyl aromatic resin;
(III) at least one ultraviolet light absorbing compound; and
(IV) at least one methine colorant.

23. The composition of claim 22, wherein the poly(arylene ether) resin is a homopolymer or a copolymer, and comprises poly(2,6-dimethyl-1,4-phenylene ether).

24. The composition of claim 22, wherein the vinyl aromatic resin is rubber-modified.

25. The composition of claim 22, wherein the poly(arylene ether) resin and the vinyl aromatic resin are each present in the composition in an amount of about 20 weight % to about 80 weight %, based on the total weight of poly(arylene ether) resin and vinyl aromatic resin.

26. The composition of claim 22, wherein the ultraviolet light absorbing compound is selected from the group consisting of benzophenone compounds, benzotriazole compounds, and combinations thereof.

27. The composition of claim 22, wherein the methine colorant comprises a compound in which a methine functional group is bonded to at least one other substituted or unsubstituted chemical group selected from the group consisting of alkyl, cycloalkyl, hydroxy, alkoxy, halogen, aryl, biphenyl, azo, cyano, ester, naphthyl, imine, and anilino.

28. The composition of claim 22, wherein the methine colorant is selected from the group consisting of Disperse Yellow 201 (Macrolex Yellow 6G), Pigment Yellow 101, Disperse Yellow 31, Disperse Yellow 61, Solvent Yellow 93, Amaplast Yellow G7, Basic Yellow 11, Basic Yellow 12, Basic Yellow 21, Solvent Yellow 79, Solvent Yellow 145, Solvent Yellow 147, Solvent Yellow 168, Solvent Yellow 169, Solvent Yellow 170, Solvent Yellow 171, Pigment Yellow 117, and combinations which comprise any of the foregoing.

29. The composition of claim 22, wherein the methine colorant has the formula 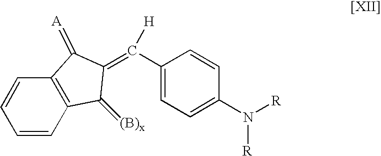
wherein each A and B is independently oxygen or C(CN)₂; each R and R′ is, independently, at least one substituted or unsubstituted group selected from the group consisting of alkyl, cycloalkyl, hydroxy, alkoxy, halogen, aryl, biphenyl, azo, and cyano; and x is either 1 or zero.

30. The composition of claim 22, wherein the methine compound is present at a level of at least about 0.015 parts by weight, based on 100 parts of the poly(arylene ether) resin and the vinyl aromatic resin.

31. The composition of claim 30, wherein the methine compound is present at a level of at least about 0.025 parts by weight.

32. The composition of claim 22, further comprising at least one hindered amine light stabilizer.

33. A thermoplastic composition, comprising:
(A) about 20 weight % to about 80 weight % of at least one polyphenylene ether resin;
(B) about 20 weight % to about 80 weight % of a rubber-modified polystyrene resin.
(C) about 0.5 weight % to about 3.0 weight % of at least one hindered amine light stabilizer, based on the weight of components (A) and (B)
(D) about 0.5 weight % to about 5 weight % of at least one ultraviolet light absorbing compound, based on the weight of components (A) and (B); and
(E) about 0.015 weight % to about 0.2 weight % of at least one methine yellow colorant, based on the weight of components (A) and (B).

34. The composition of claim 33, further comprising titanium dioxide.

35. A thermoplastic article molded from the composition of claim 22.

36. A thermoplastic article molded from the composition of claim 1.

37. A thermoplastic composition comprising poly(arylene ether) resin; vinyl aromatic resin; at least one ultraviolet light absorbing compound; and at least one methine yellow colorant;
wherein the composition has a color shift (dE) of less than about 11.0, as determined by ASTM D-2244, after weathering according to ASTM D-4459 for 300 hours.
